(19) United States
(12) Patent Application Publication
(10) Pub. No.: US 2012/0082484 A1
(43) Pub. Date: Apr. 5, 2012

(54) IMAGE FORMING APPARATUS AND IMAGE FORMING METHOD

(75) Inventors: Shoko Shimmura, Kanagawa-ken (JP); Satoshi Kinouchi, Tokyo-to (JP); Shigeru Fujiwara, Kanagawa-ken (JP); Ryota Saeki, Shizuoka-ken (JP); Kazutoshi Takahashi, Shizuoka-ken (JP); Toshihiro Sone, Kanagawa-ken (JP); Takafumi Amano, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/251,474

(22) Filed: Oct. 3, 2011

Related U.S. Application Data
(60) Provisional application No. 61/389,935, filed on Oct. 5, 2010.

(51) Int. Cl. G03G 15/01

(52) U.S. Cl. 399/223

(57) ABSTRACT

According to one embodiment, there are provided a developing section storing a color erasable developing agent that includes capsule colorant particles with a core in which a color developable compound, a color developing agent, and a color erasing agent are contained, and a developing section storing a binder resin-containing transparent developing agent. A transparent developing agent image is transferred to a region capable of covering a color erasable developing agent image and the resulting image is fixed.

### CROSS-REFERENCE TO RELATED APPLICATIONS

This application is based upon and claims the benefit of priority from U.S. Provisional Application No. 61/389,935, filed Oct. 5, 2010, the entire contents of which are incorporated herein by reference.

### FIELD

Embodiments described herein relate generally to apparatuses and methods for forming images using methods such as electrophotography, electrostatic printing, and magnetic recording.

### BACKGROUND

The amounts of paper used in offices are on the rise with an increasing volume of information handled in the information environment of offices. Meanwhile, there are diverse studies directed to cutting down consumed energy as represented by CO₂ emission. If recording media such as paper used for the temporary display and transmission of information could be recycled, it would be possible to greatly contribute to reducing consumed energy.

A toner is available that includes a microcapsule pigment and a binder resin, the former containing a color-forming agent (such as a leuco dye), a color developing agent, and a color erasing agent. The characteristic of such a toner is that the toner, colored at an ordinary temperature, is decolored at or above a certain temperature. The recorded contents on a recording medium can thus be decolored, and the recording medium can be reused to reduce the consumed energy derived from paper media. However, the microcapsule pigment used for the toner measures 0.5 to 10 μm, a size far greater than the primary particle diameter of, for example, several nanometers in the pigments used for ordinary toners. A microcapsule pigment of a smaller size is considered problematic in terms of developing a high-density color and producing sufficient intensity. On the other hand, toner particles used for electrophotographic processes should have an average particle diameter of preferably 2 to 10 μm, more preferably 3 to 7 μm, in order to form high-resolution office documents and photographic images. Indeed, it is difficult to uniformly incorporate a microcapsule pigment of a large particle diameter in the toner particles. Further, images formed with a toner that contains toner particles and colorant particles of not greatly differing sizes tend to contain the colorant particles in a non-uniform state. This makes it very difficult to control the charging characteristics, fluidity, development characteristics, and fixing characteristics of the toner. Further, even if the colorant particles could be uniformly dispersed in the toner particles, it would be necessary to cover the colorant particles with a sufficient amount of binder resin to prevent the colorant particles from separating from the binder resin during the electrophotographic process. Accordingly, the toner particle diameter tends to be gigantic, and formation of high-resolution images becomes difficult. Another problem is that the colorant particles tend to be sparsely present in the image, and fail to provide sufficient image density.

### BRIEF DESCRIPTION OF THE DRAWINGS

FIG. 1 is an exemplary view showing a schematic structure of an image forming apparatus according to an embodiment.

FIG. 2 is a model diagram representing fixing of a secondary developing agent image.

FIG. 3 is a diagram illustrating an exemplary schematic structure of an image forming apparatus according to another embodiment.

FIG. 4 is a diagram illustrating an exemplary schematic structure of an image forming apparatus according to yet another embodiment.

FIG. 5 is a diagram illustrating an exemplary schematic structure of an image forming apparatus according to still another embodiment.

FIG. 6 is a model diagram representing fixing.

### DETAILED DESCRIPTION

In general, according to one embodiment, there is provided an image forming apparatus that includes:

a first developing section that stores a color erasable developing agent and forms a color erasable first developing agent image, the color erasable developing agent including capsule colorant microparticles with a core in which a color developable compound, a color developing agent, and a color erasing agent are contained;

a second developing section that stores a binder resin-containing transparent developing agent, and forms a transparent second developing agent image in a region capable of covering the first developing agent image;

a transfer unit that transfers the first and second developing agent images onto a transfer target material; and

a fixing unit that fixes the first and second developing agent images transferred onto the transfer target material.

The first developing section forms the color erasable first developing agent image by developing an electrostatic latent image that corresponds to first image information and is formed on a first image carrier. The second developing section forms the transparent second developing agent image by developing an electrostatic latent image that corresponds to second image information and is formed on a second image carrier, the second image information being information used to form an image capable of covering the first developing agent image.

In the embodiment, the second developing agent image may be formed on the first developing agent image, or the first developing agent image may be formed on the second developing agent image.

Accordingly, the second developing section may be disposed either on the following stage of the first developing section, or on the preceding stage of the first developing section.

In the embodiment, the first developing section and the second developing section may be disposed to face their respective image carriers, specifically the first and second image carriers. Alternatively, the first developing section and the second developing section may be disposed to face a single image carrier. Specifically, the first image carrier can also serve as the second image carrier.

The capsule colorant microparticles have a volume average particle diameter of from 1 μm to 10 μm.

A volume average particle diameter of less than 1 μm tends to present difficulties electrostatically controlling the adhesion state during the development and transfer. Above 10 μm, recording of high-resolution-image information tends to become difficult.

According to another embodiment, there is provided an image forming method that includes:

forming a color erasable first developing agent image with a color erasable developing agent that includes capsule colorant microparticles with a core in which a color developable compound, a color developing agent, and a color erasing agent are contained;

forming a transparent second developing agent image in a region capable of covering the first developing agent image, using a binder resin-containing transparent developing agent;

transferring the first and second developing agent images onto a transfer target material; and

fixing the first and second developing agent images transferred onto the transfer target material.

In the formation of the first developing agent image, the color erasable first developing agent image is formed by developing the electrostatic latent image that corresponds to first image information and is formed on the first image carrier. In the formation of the second developing agent image, the transparent second developing agent image is formed by developing the electrostatic latent image that corresponds to second image information and is formed on the second image carrier, the second image information being information used to form an image capable of covering the first developing agent image.

In the embodiment, the second developing agent image may be formed on the first developing agent image, or the first developing agent image may be formed on the second developing agent image.

Accordingly, the second developing agent image may be formed either after or before forming the first developing agent image.

In the embodiment, the first developing section and the second developing section may be disposed to face their respective image carriers, specifically the first and second image carriers. Alternatively, the first developing section and the second developing section may be disposed to face a single image carrier. Specifically, the first image carrier can also serve as the second image carrier.

Certain exemplary embodiments are described below with reference to the accompanying drawings.

Note that the same reference numerals are used to represent the same elements.

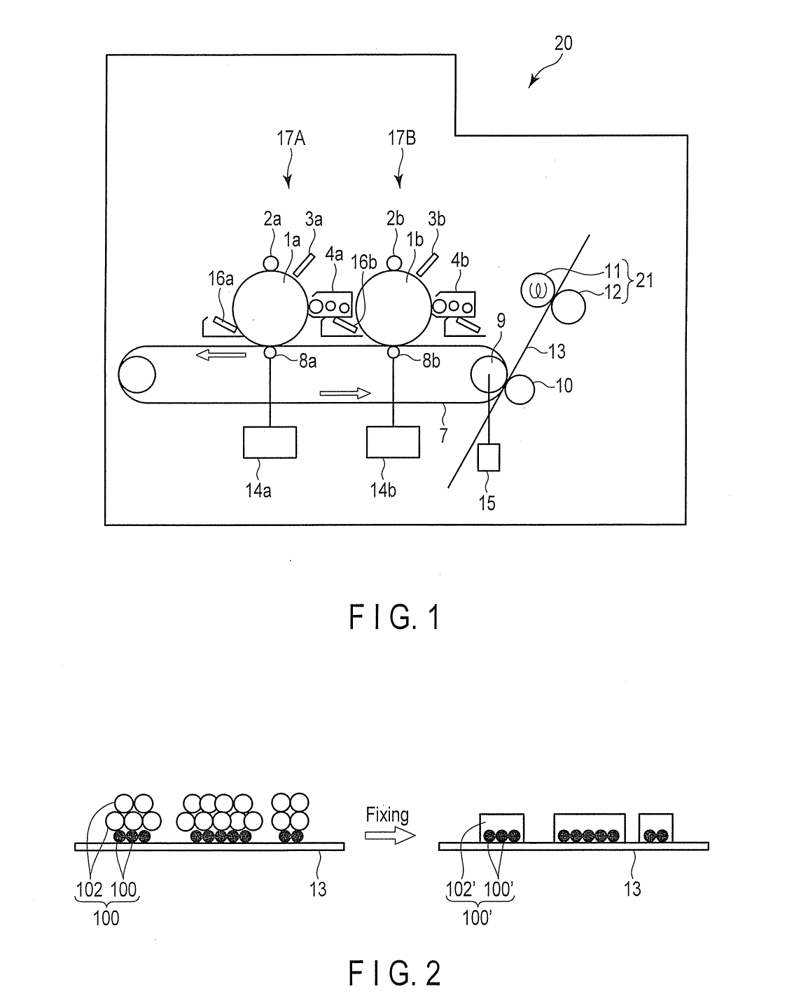

FIG. 1 is a diagram representing a schematic structure of an image forming apparatus according to an embodiment.

As illustrated in the figure, an image forming apparatus 20 includes an intermediate transfer belt 7, a second image forming unit 17B and a first image forming unit 17A provided in order on the intermediate transfer belt 7, and a fixing unit 21 provided on the downstream side.

The first image forming unit 17A includes a photoconductive drum 1a, a cleaning device 16a, a charger 2a, an exposure device 3a, a first developing section 4a, and a primary transfer roller 8a. The cleaning device 16a, the charger 2a, the exposure device 3a, and the first developing section 4a are provided in order on the photoconductive drum 1a. The primary transfer roller 8a is provided downstream of the first developing section 4a via the intermediate transfer belt 7. The first developing section 4a stores a color erasable developing agent that includes capsule colorant microparticles with a core in which a color developable compound, a color developing agent, and a color erasing agent are contained.

The second image forming unit 17B includes a photoconductive drum 1b, a cleaning device 16b, a charger 2b, an exposure device 3b, a second developing section 4b, and a primary transfer roller 8b. The cleaning device 16b, the charger 2b, the exposure device 3b, and the second developing section 4b are provided in order on the photoconductive drum 1b. The primary transfer roller 8b is provided downstream of the first developing section 4b via the intermediate transfer belt 7. The second developing section 4b stores a binder resin-containing transparent developing agent.

A secondary transfer roller 9 and a backup roller 10 are disposed face to face via the intermediate transfer belt 7 on the downstream side of the second image forming unit 17B.

The primary transfer roller 8a and the primary transfer roller 8b are connected to a primary transfer power supply 14a and a primary transfer power supply 14b, respectively. The secondary transfer roller 9 is connected to a secondary transfer power supply 15.

The fixing unit 21 includes a heat roller 11 and a pressure roller 12 disposed face to face.

The apparatus of FIG. 1 can be used to form an image, for example, as follows.

First, the charger 2b uniformly charges the photoconductive drum 1b.

This is followed by the formation of an electrostatic latent image, which is formed by exposing the photoconductive drum 1b with the exposure device 3b based on second image information used to form an image capable of covering a first developing agent image formed by the first image forming unit 17A based on first image information.

The electrostatic latent image is then developed with the binder resin-containing transparent developing agent to form a transparent second developing agent image.

The second developing agent image is transferred onto the intermediate transfer belt 7 using the primary transfer roller 8b.

The charger 2a then uniformly charges the photoconductive drum 1a.

Then, the exposure device 3a exposes the photoconductive drum 1a based on the first image information to form an electrostatic latent image.

Thereafter, a color erasable first developing agent image is formed by developing the electrostatic latent image with the color erasable developing agent that includes capsule colorant microparticles with a core in which a color developable compound, a color developing agent, and a color erasing agent are contained.

The first developing agent image is then transferred onto the second developing agent image (primary transfer) using the primary transfer roller 8a, while making sure that the first developing agent image is in register with and covered by the transparent second developing agent image on the intermediate transfer belt 7.

The primary developing agent image laminated in order of the second developing agent image and the first developing agent image on the intermediate transfer belt 7 is then transferred onto a recording medium 13 (secondary transfer) via the secondary transfer roller 9 and the backup roller 10 to form a secondary developing agent image formed from the first developing agent image and the second developing agent image laminated on the recording medium 13 in this order.

Thereafter, the fixing unit 21 applies heat and pressure with the heating roller 11 and the pressure roller 12 to fix the developing agent image on the recording medium 13.

FIG. 2 shows a model diagram representing fixing of the secondary developing agent image.

As illustrated in the figure, a secondary developing agent image 100 formed from a first developing agent image 101 and a second developing agent image 102 laminated on the first developing agent image 101 so as to cover the first developing agent image 101 is fixed on the recording medium. In this way, the capsule colorant microparticles 101′ contained in the resulting image 100′ do not assume a non-uniform state, and do not separate from a binder resin 102′ during the electrophotographic process.

The color erasable developing agent can be decolored at a decoloring temperature higher than the fixing temperature of the fixing unit. Accordingly, there is no decoloration upon the fixing alone. Further, the color erasable developing agent has such a hysteresis characteristic that the decolored state is maintained even if the temperature of the color erasable developing agent becomes lower than the decoloring temperature after the decoloration. Preferably, the decoloring temperature of the color erasable developing agent may be set to a temperature at least 5° C. higher than the fixing temperature of the fixing unit.

A less than 5° C. difference between the decoloring temperature and the fixing temperature may result in simultaneous decoloration at the time of fixing under the influence of, for example, the temperature ripple in the fixing unit.

The decoloring temperature may be set to, for example, 79° C. to 103° C.

According to the embodiment, because the capsule colorant microparticles can be layered at the same level on the transfer medium as illustrated in FIG. 1, the reflecting density can be increased more than that of the pigments that are distant apart from one another, provided that the amounts of the colorant are the same.

Because the color erasing agent is encapsulated, the colorant, the color developing agent, and the color developable compound that enable decoloration at a specific temperature can be brought closer to one another, and accordingly the decolor reaction can be made faster and more complete. Further, stable image formation can be realized by the configuration in which the capsule colorant microparticles and the binder resin particles are treated as separate developing agents, and in which the color erasable developing agent image is covered with the resin heated to melt and pressurized in the fixing, because such a configuration allows the development and transfer processes to be optimized according to the charging characteristic of each developing agent.

Further, because there is no fear of the separation between the capsule colorant microparticles and the binder resin particles during the electrophotographic process, the amount of the developed binder resin can be limited to an amount necessary to bind the capsule colorant microparticles to the transfer medium.

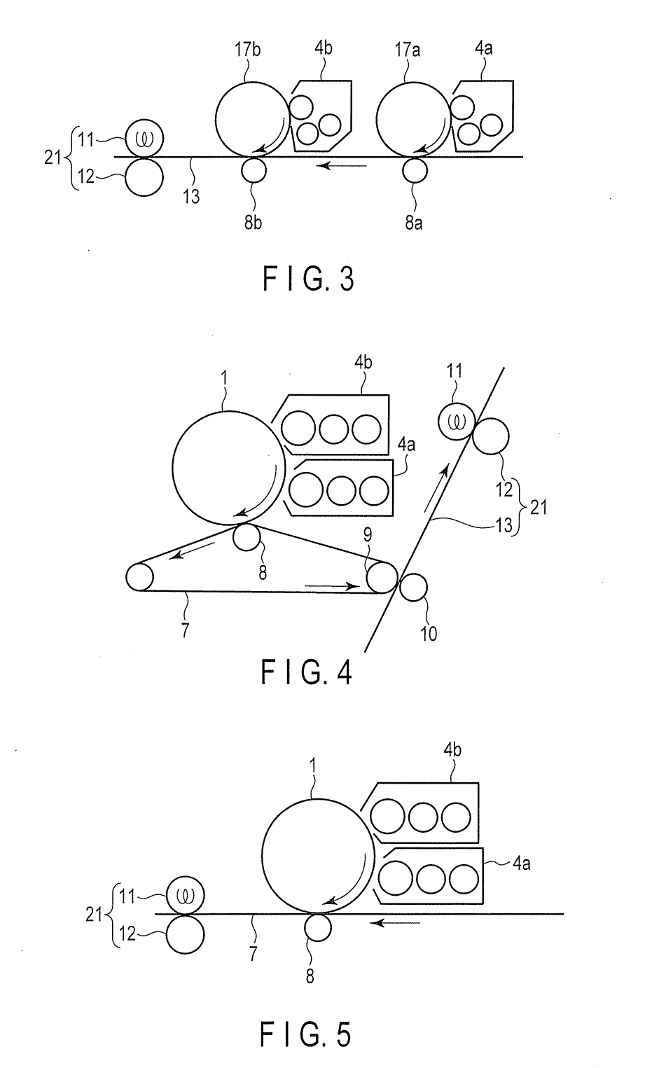

FIG. 3 to FIG. 5 illustrate exemplary schematic structures of image forming apparatuses of other embodiments.

Note that, in FIG. 3 to FIG. 5, the cleaning device, the charger, and the exposure device provided for the photoconductive drum are not illustrated for simplicity, and will not be described.

The image forming apparatus illustrated in FIG. 3 is configured in the same manner as in FIG. 1, except that the intermediate transfer belt 7 is not provided, and that the first developing agent image and the second developing agent image are directly transferred to the recording medium with the first image forming unit 17A and the second image forming unit 17B disposed in the reversed order from shown in FIG. 1. In contrast to FIG. 1 in which the transfer is performed twice, only one transfer is needed in this configuration. Accordingly, as illustrated in FIG. 3, the developing agent image formed from the first developing agent image and the second developing agent image laminated in this order can be obtained on the recording medium as in FIG. 2 with the first image forming unit 17A and the second image forming unit 17B disposed in the reversed order from that shown FIG. 1.

The image forming apparatus illustrated in FIG. 4 is configured in substantially the same manner as in FIG. 1, except that the second developing section 4b and the first developing section 4a are disposed to face a single photoconductive drum 1, instead of being disposed to face their respective photoconductive drums, namely, the second photoconductive drum 1b and the first photoconductive drum 1a. In this case, the second developing agent image and the first developing agent image are developed in this order on the photoconductive drum 1, and transferred onto the intermediate transfer belt 7 with a transfer roller 8. The developing agent image formed from the first developing agent image and the second developing agent image laminated in this order can be obtained on the recording medium as in FIG. 2 upon transferring the developing agent image transferred onto the intermediate transfer belt 7 to the recording medium 13 using the secondary transfer roller 9 and the backup roller 10.

The image forming apparatus illustrated in FIG. 5 is configured in the same manner as in FIG. 4, except that the intermediate transfer belt 7 is not used, and that the first developing agent image and the second developing agent image are directly transferred onto the recording medium with the first image forming unit 17A and the second image forming unit 17B disposed in the reversed order from shown in FIG. 4. As illustrated in FIG. 5, the developing agent image formed from the first developing agent image and the second developing agent image laminated in this order can be obtained on the recording medium as in FIG. 2 with the first image forming unit 17A and the second image forming unit 17B disposed in the reversed order from that shown FIG. 4.

Further, referring to FIG. 1 and FIGS. 3 to 5, the first image forming unit 17A and the second image forming unit 17B, or the first developing section 4a and the second developing section 4b on the photoconductive drum 1 may be disposed in the reversed order, though not illustrated. In this case, unlike in FIG. 2, the developing agent image on the recording medium is formed from the second developing agent image and the first developing agent image laminated in this order.

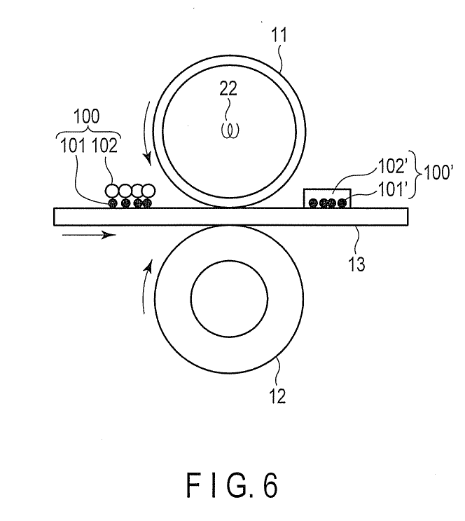

FIG. 6 is a model diagram representing fixing.

A heating roller 11 illustrated in FIG. 6 includes a Si rubber elastic layer (thickness 2 mm) and a PFA protective layer (thickness 30 μm) laminated on a 1 mm-thick SUS (outer diameter 25 mm), and a halogen lamp 22 is installed therein. A pressure roller 12 includes a Si sponge elastic layer (thickness 8 mm) around a Fe axle (Ø=11 mm), and is pressed to provide a contact width (nip width) of 8 mm between the heating roller 11 and the pressure roller 12. Thus, the heating and pressing time is about 67 msec for a recording medium passing at 60 mm/sec, and about 133 msec for a recording medium passing at 120 mm/sec.

FIG. 6 represents fixing of a developing agent image 100 obtained by laminating the first developing agent image 101 and the second developing agent image 102 in this order on the recording medium as in FIG. 2.

As illustrated in the figure, in a fixing unit 21 provided with the heating roller 11 and the pressure roller 12 disposed on the image side and the back side, respectively, of the recording medium 13, the heating roller 11 heats and melts the binder resin particles 102 to be melted under sufficient heat. Because the capsule colorant microparticles 101′ in the resulting image 100′ are not in direct contact with the heating roller 11, the capsule colorant microparticles 101′ do not easily reach the decoloring temperature, and are likely to be sufficiently covered by the binder resin particles 102 melted. As a result, fixing tends to be desirable.

If, on the other hand, the fixd image on the recording medium 13 is formed from the second developing agent image 102 and the first developing agent image 101 laminated in the reversed order from that in FIG. 2 (not illustrated), the heating roller 11 and the pressure roller 12 of FIG. 6 may be switched in position to dispose the heating roller 11 of the fixing unit on the back side of the recording medium, because it makes it easier to heat and melt the binder resin particles 102 and to improve fixing.

In this manner, the position of the heating roller in the fixing unit can be freely changed, depending on how the capsule colorant microparticles and the binder resin particles are disposed in the developing agent image transferred onto the recording medium.

The following describes the color developable compound (leuco dye, etc.), the color developing agent, and the color erasing agent used in the embodiment.

The leuco dye is an electron-donating compound that can develop color with the color developing agent. Examples of the leuco dye include diphenylmethane phthalides, phenylindolyl phthalides, indolyl phthalides, diphenylmethane azaphthalides, phenylindolyl azaphthalides, fluorans, styrylquinolines, and diazarhodamine lactones.

Specific examples include 3,3-bis(p-dimethylaminophenyl)-6-dimethylaminophthalide, 3-(4-diethylaminophenyl)-3-(1-ethyl-2-methylindol-3-yl)phthalide, 3,3-bis(1-n-butyl-2-methylindol-3-yl)phthalide, 3,3-bis(2-ethoxy-4-diethylaminophenyl)-4-azaphthalide, 3-(2-ethoxy-4-diethylaminophenyl)-3-(1-ethyl-2-methylindol-3-yl)-4-azaphthalide, 3-[2-ethoxy-4-(N-ethylanilino)phenyl]-3-(1-ethyl-2-methylindol-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-N,N-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline, spiro[5H-(1)benzopyrrano(2,3-d)pyrimidine-5,1′(3′H)isobenzofuran]-3′-one, 2-(diethylamino)-8-(diethylamino)-4-methyl-, spiro[5H-(1)benzopyrrano(2,3-d)pyrimidine-5,1′(3′H)isobenzofuran]-3′-one, 2-(di-n-butylamino)-8-(di-n-butylamino)-4-methyl-, spiro[5H-(1)benzopyrrano(2,3-d)pyrimidine-5,1′(3′H)isobenzofuran]-3′-one, 2-di-n-butylamino)-8-(diethylamino)-4-methyl-, spiro[5H-(1)benzopyrrano(2,3-d)pyrimidine-5,1′(3′H)isobenzofuran]-3′-one, 2-(di-n-butylamino)-8-(N-ethyl-N-1-amylamino)-4-methyl-, spiro[5H-(1)benzopyrrano(2,3-d)pyrimidine-5,1′(3′H)isobenzofuran]-3′-one, 2-(di-n-butylamino)-8-(di-n-butylamino)-4-phenyl, 3-(2-methoxy-4-dimethylaminophenyl)-3-(1-butyl-2-methylindol-3-yl)-4,5,6,7-tetrachlorophthalide, 3-(2-ethoxy-4-diethylaminophenyl)-3-(1-ethyl-2-methylindol-3-yl)-4,5,6,7-tetrachlorophthalide, and 3-(2-ethoxy-4-diethylaminophenyl)-3-(1-pentyl-2-methylindol-3-yl)-4,5,6,7-tetrachlorophthalide. Other examples include pyridine-, quinazoline-, and bisquinazoline-based compounds. These may be used as a mixture of two or more.

The color developing agent used in the embodiment is an electron-accepting compound that donates a proton to the leuco dye. Examples of the color developing agent include phenols, phenol metal salts, carboxylic acid metal salts, aromatic carboxylic acids, aliphatic carboxylic acids of 2 to 5 carbon atoms, benzophenones, sulfonic acids, sulfonates, phosphoric acids, phosphoric acid metal salts, acidic phosphoric acid esters, acidic phosphoric acid ester metal salts, phosphorous acids, phosphorous acid metal salts, monophenols, polyphenols, 1, 2, 3-triazole, and derivatives thereof, either unsubstituted or substituted with substituents such as an alkyl group, an aryl group, an acyl group, an alkoxycarbonyl group, a carboxy group, esters of these, an amide group, and a halogen group. Other examples include bis-, tris-phenols, phenol-aldehyde condensate resins, and metal salts of these. These may be used as a mixture of two or more.

Specific examples include phenol, o-cresol, tert-butylcatechol, nonylphenol, n-octylphenol, n-dodecylphenol, n-stearylphenol, p-chlorophenol, p-bromophenol, o-phenylphenol, n-butyl p-hydroxybenzoate, n-octyl p-hydroxybenzoate, benzyl p-hydroxybenzoate, dihydroxybenzoic acid and an ester thereof (for example, 2,3-dihydroxybenzoic acid, and methyl 3,5-dihydroxybenzoate), resorcin, gallic acid, dodecyl gallate, ethyl gallate, butyl gallate, propyl gallate, 2,2-bis(4-hydroxyphenyl)propane, 4,4-dihydroxydiphenylsulfone, 1,1-bis(4-hydroxyphenyl)ethane, 2,2-bis(4-hydroxy-3-methylphenyl)propane, bis(4-hydroxyphenyl)sulfide, 1-phenyl-1,1-bis(4-hydroxyphenyl)ethane, 1,1-bis(4-hydroxyphenyl)-3-methylbutane, 1,1-bis(4-hydroxyphenyl)-2-methylpropane, 1,1-bis(4-hydroxyphenyl)n-hexane, 1,1-bis(4-hydroxyphenyl) n-heptane, 1,1-bis(4-hydroxyphenyl)n-octane, 1,1-bis(4-hydroxyphenyl)n-nonane, 1,1-bis(4-hydroxyphenyl)n-decane, 1,1-bis(4-hydroxyphenyl)n-dodecane, 2,2-bis(4-hydroxyphenyl)butane, 2,2-bis(4-hydroxyphenyl) ethylpropionate, 2,2-bis(4-hydroxyphenyl)-4-methylpentane, 2,2-bis(4-hydroxyphenyl)hexafluoropropane, 2,2-bis(4-hydroxyphenyl)n-heptane, 2,2-bis(4-hydroxyphenyl)n-nonane, 2,4-dihydroxyacetophenone, 2,5-dihydroxyacetophenone, 2,6-dihydroxyacetophenone, 3,5-dihydroxyacetophenone, 2,3,4-trihydroxyacetophenone, 2,4-dihydroxybenzophenone, 4,4′-dihydroxybenzophenone, 2,3,4-trihydroxybenzophenone, 2,4,4′-trihydroxybenzophenone, 2,2′,4,4′-tetrahydroxybenzophenone, 2,3,4,4′-tetrahydroxybenzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl]-1,2,3-benzenetriol, 4,6-bis[(3,5-dimethyl-4-hydroxyphenyl)methyl]-1,2,3-benzenetriol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidenetrisphenol, 4,4′-(1-methylethylidene)bisphenol, and methylene tris-p-cresol.

The color erasing agent used in the embodiment may be a known color erasing agent, provided that it can erase color by inhibiting the chromogenic reaction between the leuco dye and the color developing agent under heat in the three-component system of the color developable compound, the color developing agent, and the color erasing agent.

The color erasing agent may be used in the form of (1) a dispersion of a color component (developing a color by the binding of the leuco dye and the color developing agent) and a color erasing agent component in a medium that has small or no color-developing and decoloring effects, or (2) a color erasing agent component used as a medium of the component developing a color by the binding of the leuco dye and the color developing agent.

The color erasing agent used in the form (2) is known from JP-A-60-264285, JP-A-2005-1369, and JP-A-2008-280523, which describe a color-decolor mechanism utilizing the temperature hysteresis of the color erasing agent and thus having superior instantaneous erasability. The color of the three-component system mixture can be erased by heating the mixture to a temperature equal to or greater than a specific decoloration temperature Th. The decolored state can be maintained even after the decolored mixture is cooled down to a temperature below Th. Upon lowering the temperature further, a reversible color-decolor reaction can take place, whereby the chromogenic reaction between the leuco dye and the color developing agent is restored at or below a specific color restoring temperature Tc to return to the colored state. Preferably, the color erasing agent used in the embodiment satisfies the relation Th>Tr>Tc, where Tr is room temperature.

Examples of color erasing agents that can exhibit such temperature hysteresis include alcohols, esters, ketones, ethers, and acid amides.

Of these, esters are particularly preferred. Specific examples include carboxylic acid esters that contain a substituted aromatic ring; esters of unsubstituted aromatic ring-containing carboxylic acid and aliphatic alcohol; carboxylic acid esters that contain a cyclohexyl group within the molecule; esters of fatty acid and unsubstituted aromatic alcohol or phenol; esters of fatty acid and branched aliphatic alcohol; esters of dicarboxylic acid and aromatic alcohol or branched aliphatic alcohol; dibenzyl cinnamate; heptyl stearate; didecyl adipate; dilauryl adipate; dimyristyl adipate; dicetyl adipate; distearyl adipate; trilaurin; trimyristin; tristearin; dimyristin; and distearin. These may be used as a mixture of two or more.

The color erasing agent of the form (1) may be one known from, for example, JP-A-2000-19770. Examples include cholesterol, stigmasterol, pregnenolone, methyl androstenediol, estradiol benzoate, epiandrosterone, stenolon, β-sitosterol, pregnenoloneacetate, β-cholestanol, 5,16-pregnadiene-3β-ol-20-one, 5α-pregnen-3β-ol-20-one, 5-pregnen-3β, 17-diol-20-one-21-acetate, 5-pregnen-3β, 17-diol-20-one-17-acetate, 5-pregnen-3β, 21-diol-20-one-21-acetate, 5-pregnen-3β, 17-diol diacetate, rockogenin, tigogenin, esmilagenin, hecogenin, diosgenin, cholic acid, cholic acid methyl ester, sodium cholate, lithocholic acid, lithocholic acid methyl ester, sodium lithocholate, hydroxycholic acid, hydroxycholic acid methyl ester, hyodeoxycholic acid, hyodeoxycholic acid methyl ester, testosterone, methyltestosterone, 11α-hydroxymethyltestosterone, hydrocortisone, cholesterol methyl carbonate, α-cholestanol, D-glucose, D-mannose, D-galactose, D-fructose, L-sorbose, L-rhamnose, L-fucose, D-ribodesose, α-D-glucose pentaacetate, acetoglucose, diacetone-D-glucose, D-glucuronic acid, D-galacturonic acid, D-glucosamine, D-fructosamine, D-isosaccharic acid, vitamin C, erythorbic acid, trehalose, saccharose, maltose, cellobiose, gentiobiose, lactose, melibiose, raffinose, gentianose, melezitose, stachyose, methyl α-glucopyranoside, salicin, amygdalin, euxanthic acid, cyclododecanol, hexahydrosalicylic acid, menthol, isomenthol, neomenthol, neoisomenthol, carbomenthol, α-carbomenthol, piperitol, α-terpineol, β-terpineol, γ-terpineol, 1-p-menthen-4-ol, isopulegol, dihydrocarveol, carveol, 1,4-cyclohexanediol, 1,2-cyclohexanediol, phloroglucitol, quercitol, inositol, 1,2-cyclododecanediol, quinic acid, 1,4-terpine, 1,8-terpine, pinol hydrate, betulin, borneol, isoborneol, adamantanol, norborneol, fenchol, camphor, and 1,2:5,6-diisopropylidene-D-mannitol.

The mixed proportions of the leuco dye, the color developing agent, and the color erasing agent vary with the concentration, the discoloration temperature, and the type of each component. The proportion of the color developing agent ranges from 0.1 to 100, preferably 0.1 to 50, more preferably 0.5 to 20, and the proportion of the color erasing agent ranges from 1 to 800, preferably 5 to 200, more preferably 5 to 100 with respect to the leuco dye 1 in terms of a weight ratio.

### EXAMPLES

### Preparation of Capsule Colorant Microparticle

### Developing Agent

### Capsule Colorant Microparticles (1)

A color erasable toner composition was uniformly heated and dissolved to obtain a core solution. The color erasable toner composition contained 1 weight part of the color developable compound 3-(2-ethoxy-4-diethylaminophenyl)-3-(1-ethyl-2-methylindol-3-yl)-4-azaphthalide, 5 weight parts of the color-forming agent 2,2-bis(4′-hydroxyphenyl)hexafluoropropane, and 50 weight parts of a diester of pimelic acid and 2-(4-benzyloxyphenyl)ethanol as the color erasing agent.

An aromatic polyvalent isocyanate prepolymer (25 weight parts; wall material), and ethyl acetate (25 weight parts; co-solvent) were then mixed with 25 weight parts of the color developable compound composition to obtain a core-shell solution.

The core-shell solution was emulsified and dispersed as micro droplets in the polyvinyl alcohol aqueous solution, and water-soluble aliphatic modified amine was added after stirring the mixture under heat. The mixture was further stirred to obtain a capsule colorant microparticle suspension. The suspension was centrifuged to isolate the capsule colorant microparticles (1). The capsule colorant microparticles (1) had a volume average particle diameter of 5 μm, a complete decoloring temperature of 79° C., and a complete color developing temperature of −10° C. The color of the capsule colorant microparticles (1) reversibly changes between a blue color and colorless with temperature changes.

### Developing Agent A (1)

Silica (NAX50: Nippon Aerosil Co., Ltd.; 3 weight parts), and titanium oxide (NKT90: Nippon Aerosil Co., Ltd.; 1.2 weight parts) were mixed with the capsule colorant microparticles (1) (100 weight parts), and thoroughly stirred to cause the inorganic microparticles to uniformly adhere to the surfaces of the capsule colorant microparticles (1).

These particles (6 weight parts) were then mixed with carrier particles (94 weight parts) that had a volume average particle diameter of 40 μm and obtained by the acryl resin coating of a ferrite surface. As a result, developing agent A (1) was obtained. The developing agent A (1) was charged to an average charge of −23 μC/g.

### Capsule Colorant Microparticles (2)

A color erasable toner composition that contained the color developable compound crystal violet lactone (1 weight part), the color developing agent benzyl 4-hydroxybenzoate (5 weight parts), and the color erasing agent 4-benzyloxyphenylethyl laurate (50 weight parts) was uniformly heated and dissolved to obtain a core solution.

A mixture of an aromatic polyvalent isocyanate prepolymer (25 weight parts; wall material) and ethyl acetate (50 weight parts; co-solvent) was then mixed with the color developable compound composition (25 weight parts) to obtain a core-shell solution.

The core-shell solution was emulsified and dispersed as micro droplets in the polyvinyl alcohol aqueous solution, and water-soluble aliphatic modified amine was added after stirring the mixture under heat. The mixture was further stirred to obtain a capsule colorant microparticle suspension. The suspension was then centrifuged to isolate the capsule colorant microparticles (2). The capsule colorant microparticles (2) had a volume average particle diameter of 5 μm, a complete decoloring temperature of 103° C., and a complete color developing temperature of −15° C. The color of the capsule colorant microparticles (2) reversibly changes between a blue color and colorless with temperature changes.

### Developing Agent A2

Silica (NAX50: Nippon Aerosil Co., Ltd.; 3 weight parts), and titanium oxide (NKT90: Nippon Aerosil Co., Ltd.; 1.2 weight parts) were mixed with the capsule colorant microparticles (2) (100 weight parts), and thoroughly stirred to cause the inorganic microparticles to uniformly adhere to the surfaces of the capsule colorant microparticles (2). These particles (6 weight parts) and carrier particles (94 weight parts) that had a volume average particle diameter of 40 μm and obtained by the acryl resin coating of a ferrite surface were mixed to obtain developing agent A (2). The developing agent A (2) was charged to an average charge of −25 μC/g.

### Preparation of Binder Resin Particle Developing Agent

### Resin Particles (1)

Terephthalic acid (39 parts by mass), a bisphenol A ethylene oxide compound (61 parts by mass), and dibutyltin (0.2 parts by mass) were charged into an esterification reaction vessel, and a polycondensation reaction was performed in a nitrogen atmosphere at 260° C. for 5 hours under 50 KPa to obtain a polyester resin.

The polyester resin had a glass transition temperature Tg of 60° C., a softening point Tm of 110° C., and a weight average molecular weight of 12,000. The polyester resin (95 weight parts) was then mixed and kneaded with a release agent (rice wax; 5 weight parts), pulverized, and classified to obtain resin particles (1) that had a volume average particle diameter of 9.8 μm.

Silica (NAX50; 1.7 weight parts) and titanium oxide (NKT90; 0.6 weight parts) were then mixed with the resin particles (1) (100 weight parts), and thoroughly stirred to cause the inorganic microparticles to uniformly adhere to the surfaces of the resin particles. These particles (8 weight parts) were mixed with carrier particles (92 weight parts) that had a volume average particle diameter of 40 μm and obtained by the acryl resin coating of a ferrite surface. As a result, developing agent B (1) was obtained. The developing agent B (1) was charged to an average charge of −31 μC/g.

Note that the softening point was measured using a flow tester CFT-500D (Takatsu MFG Co., Ltd.) and a sample (1.45 to 1.50 g) formed with a pressurizer and attached inside a flow tester cylinder, under the following conditions.

Rate of temperature increase: 2.5° C./min

Die hole diameter: 1 mm

Load: 10 kgf

Air pressure: 0.4 Mpa

The middle point of the stroke position between the softening point and the end of the flow was measured as the temperature Tm (softening point).

### Production of Binder Resin Particle Dispersion

The polyester resin was pulverized, and sodium dodecylbenzenesulfonate (0.4 parts) and tritylamine (1 part) were added to prepare a suspension. The suspension was atomized by mechanical shear using a high-pressure homogenizer, and a dispersion of binder resin-containing particles was prepared as a core solution.

### Production of Styrene-Acryl Resin as Shell Material

Styrene (90 parts by mass), n-butyl acrylate (10 parts by mass), sodium p-styrenesulfonate (100 ppm), the chain transfer agent tert-dodecylmercaptan (1.5 parts by mass), the emulsifier Latemul PS (Kao Corporation; 0.5 parts by mass) were added, and emulsion polymerization was performed at 60° C. upon adding the polymerization initiator ammonium persulfate (0.8 parts by mass) to obtain a styrene-acryl resin emulsion as a shell solution. The styrene-acryl resin had a glass transition temperature of 80° C., and a weight average molecular weight of 25,000.

### Agglomeration and Fusing

A dispersion of the binder resin-containing particles (95 parts by mass), and a dispersion of the release agent (rice wax; 5 parts by mass) were agglomerated at 50° C. with aluminum sulfate Al₂ (SO₄)₃ (3.0 mass %), and the styrene-acryl resin emulsion (20 parts by mass) was added to encapsulate the resin particles. For fusing, the temperature was raised to 75° C. at a rate of temperature increase of 5° C./30 min, followed by washing and drying. As a result, resin particles (2) with a volume average particle diameter of 10.3 μm were obtained.

Silica (NAX50; 1.6 weight parts) and titanium oxide (NKT90; 0.5 weight parts) were then added to the resin particles (2) (100 weight parts), and the mixture was thoroughly stirred to cause the inorganic microparticles to uniformly adhere to the resin particle surface. These particles (8 weight parts) were then mixed with carrier particles (92 weight parts) that had a volume average particle diameter of 40 μm and obtained by the acryl resin coating of a ferrite surface. As a result, developing agent B (2) was obtained. The developing agent B (2) was charged to an average charge of −32 μC/g.

### Example 1

The developing agent B (1) and the developing agent A (1) were stored in the second developing section 4b and the first developing section 4a, respectively, of the image forming apparatus illustrated in FIG. 1.

The capsule colorant microparticles (1) and the resin particles (1) were then transferred onto a recording medium in the form of an image. With the fixing unit temperature set to 73° C., the recording medium was passed through the fixing unit at about 60 mm/sec (15 ppm). The heat and pressure applied in the nip of the fixing unit melted the fusing binder resin without raising the temperature of the coloring agent to the decoloring temperature, and the binder resin, having coated the colored particles, was cooled outside of the fixing unit to obtain a fixed color image on the recording medium.

Heating the color image to 79° C. or higher using an erasing apparatus (not illustrated) decolored the coloring agent, and enabled the recording medium to be reused as a blank sheet of paper.

### Example 2

The developing agent B (2) and the developing agent A (2) were stored in the developing section 4b and the developing section 4a, respectively, and the capsule colorant microparticles (2) and the resin particles (2) were transferred onto a recording medium in the form of an image. With the fixing unit r temperature set to 85° C., the recording medium was passed through the fixing unit at about 120 mm/sec (28 ppm). The applied heat and pressure in the nip of the fixing unit melted the fixing binder resin without raising the temperature of the coloring agent to the decoloring temperature, and the binder resin, having coated the colored particles, was cooled outside of the fixing unit to obtain a fixed color image on the recording medium.

Heating the color image to 103° C. or higher using an erasing apparatus (not illustrated) decolored the coloring agent, and enabled the recording medium to be reused as a blank sheet of paper.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a first developing section facing a first image carrier and storing a color erasable developing agent that includes capsule colorant microparticles with a core in which a color developable compound, a color developing agent, and a color erasing agent are contained, the first developing section forming a color erasable first developing agent image by developing an electrostatic latent image that corresponds to first image information and is formed on the first image carrier;
a second developing section facing a second image carrier and storing a binder resin-containing transparent developing agent, the second developing section forming a transparent second developing agent image by developing an electrostatic latent image that corresponds to second image information and is formed on the second image carrier, the second image information being information for forming an image capable of covering the first developing agent image;
a transfer unit that transfers the first and second developing agent images onto a transfer target material; and
a fixing unit that fixes the first and second developing agent images transferred onto the transfer target material.

2. The apparatus according to claim 1, wherein the color erasable developing agent is decolored at a decoloring temperature higher than a fixing temperature of the fixing unit, and has such a hysteresis characteristic that the decolored state is maintained even at a color erasable developing agent temperature below the decoloring temperature.

3. The apparatus according to claim 1, further comprising an intermediate transfer medium used to temporarily transfer the first and second developing agents and to transfer the temporary transfer image to the transfer target material.

4. The apparatus according to claim 1, wherein the first image carrier also serves as the second image carrier.

5. An image forming method, comprising:
forming a color erasable first developing agent image by developing an electrostatic latent image that corresponds to first image information and is formed on a first image carrier, the color erasable first developing agent image being formed by using a color erasable developing agent that includes capsule colorant microparticles with a core in which a color developable compound, a color developing agent, and a color erasing agent are contained;
forming a transparent second developing agent image with an image binder resin-containing transparent developing agent by developing an electrostatic latent image that corresponds to second image information and is formed on a second image carrier, the second image information being information for forming an image capable of covering the first developing agent image;
transferring the first and second developing agent images onto a transfer target material; and
fixing the first and second developing agent images transferred onto the transfer target material.

6. The method according to claim 5, wherein the color erasable developing agent is decolored at a decoloring temperature higher than a fixing temperature of a fixing unit, and has such a hysteresis characteristic that the decolored state is maintained even at a color erasable developing agent temperature below the decoloring temperature.

7. The method according to claim 5, wherein the transfer of the first and second developing agents onto the transfer target material involves temporarily transferring the first and second developing agents onto an intermediate transfer medium to form a temporary transfer image, and transferring the temporary transfer image onto the transfer target material.

8. The method according to claim 5, wherein the first image carrier also serves as the second image carrier.
